(19) United States
(12) Patent Application Publication
(10) Pub. No.: US 2020/0369872 A1
(43) Pub. Date: Nov. 26, 2020

(54) PHA TERPOLYMER COMPOSITIONS

(71) Applicant: Danimer Bioplastics, Inc., Bainbridge, GA (US)

(72) Inventors: Phillip Van Trump, Decatur, GA (US); Richard Eaton, Athens, GA (US); Joe B. Grubbs, III, Bishop, GA (US)

(73) Assignee: Danimer Bioplastics, Inc., Bainbridge, GA (US)

(21) Appl. No.: 16/880,135

(22) Filed: May 21, 2020

Related U.S. Application Data
(60) Provisional application No. 62/852,443, filed on May 24, 2019.

(51) Int. Cl. C08L 67/04; C08L 67/02; C08L 27/06; C08L 23/06; C08L 23/12; C08K 5/00; C08K 3/013; B29C 48/00

(52) U.S. Cl. CPC C08L 67/04; C08L 67/02; C08L 27/06; C08L 23/06; C08L 23/12; C08L 2205/24; C08K 3/013; C08K 5/0016; B29C 48/022; C08L 2201/06; C08L 2205/02; C08K 5/0083

(57) ABSTRACT

A polymer composition is disclosed which includes at least a first biodegradable copolymer. This first biodegradable copolymer is itself made up of: (1) from about 55 to about 99.5 mole percent monomer residues of 3-hydroxybutyrate, (2) monomer residues of a secondary monomer selected from the group consisting of 4-hydroxybutyrate, 3-hydroxyvalerate, 4-hydroxyvalerate, and 5-hydroxyvalerate, and (3) monomer residues of a tertiary monomer selected from the group consisting of hydroxyalkanoate monomers having from 6 to 22 carbon atoms.

### FIELD

This disclosure relates to biodegradable polymeric compositions. More particularly, this disclosure relates to biodegradable polymeric compositions including co-polymers of polyhydroxyalkanoates (“PHA's”) having at least three different monomer units, i.e. PHA terpolymers.

### BACKGROUND

Biodegradable polymers are an area of increasing commercial interest. Advantageously, biodegradable polymers may be derived from renewable biomass resources, rather than from fossil fuels. Moreover, biodegradable polymers products are biodegradable, in contrast to conventional petroleum-based polymers which can take centuries to degrade after typical landfill disposal.

An important class of biodegradable polymer are polyhydroxyalkanoates or PHAs. PHAs are biodegradable aliphatic polyesters are typically produced by large-scale bacterial fermentation. There are a wide variety of different polymer structures within the class of PHA polymers, including both homopolymer and copolymer forms.

While being desirably biodegradable, the mechanical properties of many PHAs have been found to be less than ideal. In some instances, PHAs have been found to be less than ideal with respect to tensile strength, flexural modulus, impact strength, hardness, and/or elongation at break. While these deficiencies can be remedied to some extent by the inclusion of additives, it would be preferable to identify forms of PHA which inherently exhibit improved mechanical properties.

Thus, it would be desirable to provide specific forms of PHAs which exhibit improved mechanical properties and to provide various articles manufactured from such PHAs.

### SUMMARY OF THE INVENTION

The above and other needs are met by a polymer composition in accordance with the current disclosure. According to one embodiment, this polymer composition includes at least a first biodegradable copolymer. This first biodegradable copolymer is itself made up of: (1) from about 55 to about 99.5 mole percent monomer residues of 3-hydroxybutyrate, (2) monomer residues of a secondary monomer selected from the group consisting of 4-hydroxybutyrate, 3-hydroxyvalerate, 4-hydroxyvalerate, and 5-hydroxyvalerate, and (3) monomer residues of a tertiary monomer selected from the group consisting of hydroxyalkanoate monomers having from 6 to 22 carbon atoms.

In certain embodiments, the secondary monomer is preferably 3-hydroxyvalerate. In other embodiments, however, the secondary monomer is preferably 4-hydroxybutyrate. In still other embodiments, the secondary monomer is preferably 4-hydroxyvalerate or 5-hydroxyvalerate.

In certain embodiments, the tertiary monomer is preferably 3-hydroxyhexanoate. In some other embodiments, the tertiary monomer is preferably 3-hydroxyoctanoate. In still other embodiments, the tertiary monomer is preferably 3-hydroxydecanoate.

In certain embodiments, the first biodegradable copolymer is preferably made up of from about 0.01 to about 20 mole percent (preferably 0.01 to 5 mole percent) monomer residues of the secondary monomer, and from about 1 to about 35 mole percent monomer residues of the tertiary monomer. According to certain embodiments, the first biodegradable copolymer is more preferably made up of: (1) from about 84 to about 99.5 mole percent monomer residues of 3-hydroxybutyrate, (2) from about 0.1 to about 1.0 mole percent monomer residues of a secondary monomer selected from the group consisting of 4-hydroxybutyrate, 3-hydroxyvalerate, 4-hydroxyvalerate, and 5-hydroxyvalerate, and (3) from about 0.4 to about 15 mole percent monomer residues of a tertiary monomer selected from the group consisting of hydroxyalkanoate monomers having from 6 to 22 carbon atoms.

In other embodiments however, the first biodegradable copolymer is preferably made up of from about 1 to about 35 mole percent monomer residues of the secondary monomer, and from about 0.01 to about 20 mole percent (preferably 0.01 to 5 mole percent) monomer residues of the tertiary monomer. In some instances, the first biodegradable copolymer is more preferably made up of: (1) from about 84 to about 99.5 mole percent monomer residues of 3-hydroxybutyrate, (2) from about 0.4 to about 15 mole percent monomer residues of a secondary monomer selected from the group consisting 4-hydroxybutyrate, 3-hydroxyvalerate, 4-hydroxyvalerate, and 5-hydroxyvalerate, and (3) from about 0.1 to about 1.0 mole percent monomer residues of a tertiary monomer selected from the group consisting of hydroxyalkanoate monomers having from 6 to 22 carbon atoms.

In certain embodiments, the first biodegradable copolymer preferably has a weight average molecular weight from about 50,000 to about 7.5 million Daltons. More preferably, the first biodegradable copolymer has a weight average molecular weight from about 450,000 to about 3.0 million Daltons. Most preferably, the first biodegradable copolymer has a weight average molecular weight from about 350,000 to about 1.5 million Daltons.

In certain embodiments, the polymer composition includes from about 50 weight percent to about 95 weight percent of the first biodegradable copolymer. Moreover, the polymer composition also preferably includes from about 5 weight percent to about 50 weight percent of a second biodegradable polymer selected from the group consisting of polybutylene adipate terephthalate, polybutylene succinate, polybutylene succinate-co-butylene adipate, polylactic acid, mesolactide, polycaprolactone, polyglycolide, starches, cellulose esters, polysaccharides, polyvinyl alcohol, polyvinyl acetate, polymaleic acid, copolyesters of diols having 2 to 18 carbon atoms and diacids having 2 to 18 carbon atoms, and mixtures thereof.

In some instances, the first biodegradable copolymer is preferably blended or reactively extruded with the second biodegradable polymer.

In other instances, the first biodegradable copolymer is preferably blended or reactively extruded with additional polyhydroxyalkanoates.

In certain embodiments, the polymer composition includes from about 50 weight percent to about 95 weight percent of the first biodegradable copolymer. Moreover, the polymer composition also preferably includes from about 5 weight percent to about 50 weight percent of a nonbiodegradable polymer selected from the group consisting of polyvinyl chloride, polypropylene, polyethylene, polyethylene terephthalate, and mixtures thereof.

In certain embodiments, the polymer composition also includes from about 0.01 weight percent to about 20 weight percent of a nucleating agent selected from the group consisting of (1) compounds having an orthorhombic crystal structure, (2) compounds having a hexagonal crystal structure, (3) compounds having a tetragonal crystal structure, (4) allotrophic elements having at least one crystalline form which is orthorhombic, hexagonal, or tetragonal, (5) polymorphic compounds having at least one crystalline form which is orthorhombic, hexagonal, or tetragonal, and (6) mixtures thereof. For instance, the nucleating agent may, in some embodiments, be selected from the group consisting of artificial sweeteners, boron nitride, thymine, pentaerythritol, dipentaerythritol, anatase, wulfenite, aragonite, sulfur, selenium, phosphorous, and benzamide.

In some embodiments, the polymer composition also includes from about 1.0 weight percent to about 40 weight percent of a filler selected from the group consisting of clays, calcium carbonate, talc, kaolinite, montmorillonite, bentonite, silica, chitin, titanium dioxide, nano clay, nanocellulose, or mixtures thereof.

In certain embodiments, the polymer composition also includes from about 0.5 weight percent to about 25 weight percent of a plasticizer selected from the group consisting of sebacates, citrates, fatty esters of adipic, succinic, and glutaric acids, lactates, alkyl diesters having a having a main carbon chain of from about 2 to about 12 carbon atoms, alkyl methyl esters, dibenzoates, propylene carbonate, caprolactone diols having a weight average molecular weight from about 200 to about 10,000, polyethylene glycols diols having a weight average molecular weight from about 400 to about 10,000, esters of vegetable oils (such as soybean, canola, corn, cottonseed, sunflower, and peanut oils), long chain alkyl acids having from about 10 to about 20 carbon atoms, glycerol, isosorbide derivatives and mixtures thereof.

A variety of articles may be formed from the polymer composition of the present disclosure. For instance, in one embodiment of the present disclosure, a molded article is provided which made up of at least 50 weight percent of the aforementioned polymer composition.

In a different embodiment of the present disclosure, an extruded article is provided which made up of at least 50 weight percent of the aforementioned polymer composition.

In another embodiment of the present disclosure, a fiber or filament is provided which made up of at least 50 weight percent of the aforementioned polymer composition.

In yet another embodiment of the present disclosure, a polymeric film is provided which made up of at least 50 weight percent of the aforementioned polymer composition.

In still another embodiment of the present disclosure, a foamed article is provided which made up of at least 50 weight percent of the aforementioned polymer composition.

In a further embodiment of the present disclosure, a dispersion, generally an aqueous dispersion, is provided which made up of at least 50 weight percent of the aforementioned polymer composition.

### DETAILED DESCRIPTION

According to the present disclosure, a polymeric composition is provided. According to one embodiment, this polymer composition includes at least a first biodegradable copolymer.

The first biodegradable copolymer is itself generally made of at least one polyhydroxyalkanoate (“PHA”) copolymer and more particularly a PHA copolymer formed from at least 3 different types of monomer residues. i.e., a PHA terpolymer.

The first group of monomer residues are formed from a primary monomer, which is generally 3-hydroxybutyrate. Thus, these monomer residues have the structure:

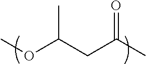

The monomer residues of 3-hydroxybutyrate generally make up from about from about 55 to about 99.5 mole percent of the PHA monomer residues in the first biodegradable copolymer.

The second group of monomer residues are formed from a secondary monomer, which is generally selected from the group consisting of 4-hydroxybutyrate, 3-hydroxyvalerate, 4-hydroxyvalerate, and 5-hydroxyvalerate. Thus, these secondary monomer residues have one of the following structures:

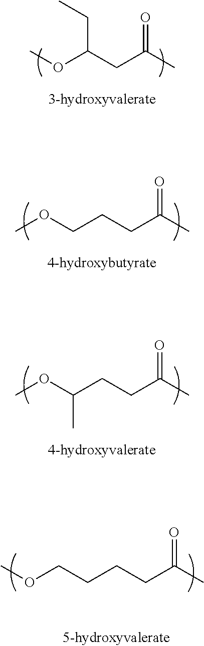

Thus, in some instances, the secondary monomer is preferably 3-hydroxyvalerate. In other instances, the secondary monomer is preferably 4-hydroxybutyrate. In still other instances, the secondary monomer is preferably 4-hydroxyvalerate, or 5-hydroxyvalerate. In further embodiments, the secondary monomer may be made of a mixture of 4-hydroxybutyrate, 3-hydroxyvalerate, 4-hydroxyvalerate, and 5-hydroxyvalerate

The third group of monomer residues are formed from a tertiary monomer, which is generally selected from the group consisting of hydroxyalkanoate monomers having from 6 to 22 carbon atoms. Thus, these tertiary monomer residues have the structure:

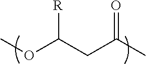

wherein each R is a C₃ to C₁₉ alkyl group.

In some instances, the tertiary monomer is preferably 3-hydroxyhexanoate. In other instances, the tertiary monomer is preferably 3-hydroxyoctanoate or 3-hydroxydecanoate.

In certain especially preferred embodiments according to the present disclosure, the primary monomer is 3-hydroxybutyrate, the secondary monomer is 3-hydroxyvalerate, and the tertiary monomer is 3-hydroxyhexanoate.

In some instances, the molar amount of the secondary monomer residues will be less than the molar amount of the tertiary monomer residues in the first biodegradable copolymer. For instance, the first biodegradable copolymer may be made up of from about 0.01 to about 20 mole percent (preferably 0.01 to 5 mole percent) monomer residues of the secondary monomer, and from about 1 to about 35 mole percent monomer residues of the tertiary monomer. More preferably, the first biodegradable copolymer is made up of: (1) from about 84 to about 99.5 mole percent monomer residues of 3-hydroxybutyrate, (2) from about 0.1 to about 1.0 mole percent monomer residues of a secondary monomer selected from the group consisting of 4-hydroxybutyrate, 3-hydroxyvalerate, 4-hydroxyvalerate, and 5-hydroxyvalerate, and (3) from about 0.4 to about 15 mole percent monomer residues of a tertiary monomer selected from the group consisting of hydroxyalkanoate monomers having from 6 to 22 carbon atoms.

In some instances, however, the molar amount of the secondary monomer residues will be greater than the molar amount of the tertiary monomer residues in the first biodegradable copolymer. For instance, the first biodegradable copolymer may be made up of from about 1 to about 35 mole percent monomer residues of the secondary monomer, and from about 0.01 to about 20 mole percent (preferably 0.01 to 5 mole percent) monomer residues of the tertiary monomer. More preferably, the first biodegradable copolymer is made up of: (1) from about 84 to about 99.5 mole percent monomer residues of 3-hydroxybutyrate, (2) from about 0.4 to about 15 mole percent monomer residues of a secondary monomer selected from the group consisting of 4-hydroxybutyrate, 3-hydroxyvalerate, 4-hydroxyvalerate, and 5-hydroxyvalerate, and (3) from about 0.1 to about 1.0 mole percent monomer residues of a tertiary monomer selected from the group consisting of hydroxyalkanoate monomers having from 6 to 22 carbon atoms.

In some instances, the first biodegradable copolymer is preferably blended or reactively extruded with the second biodegradable polymer.

In other instances, the first biodegradable copolymer is preferably blended or reactively extruded with additional polyhydroxyalkanoates.

The molecular weight of the first biodegradable copolymer may vary somewhat in according to the present disclosure. In general, however, the first biodegradable copolymer typically has a weight average molecular weight from about 50,000 to about 7.5 million Daltons. More preferably, the first biodegradable copolymer typically has a weight average molecular weight from about 350,000 to about 1.5 million Daltons. Most preferably, the first biodegradable copolymer has a weight average molecular weight from about 350,000 to about 1.5 million Daltons.

Advantageously, the first biodegradable copolymer according to the present disclosure exhibits improved mechanical properties as compared to conventional polyhydroxyalkanoates copolymers. In some instances, the first biodegradable copolymer according to the present disclosure may have a lower glass transition temperature (T_{g}) and/or melting temperature (Tₘ) as compared to conventional polyhydroxyalkanoate homopolymers and copolymers made up of only one or two types monomer residues. In some instances, the first biodegradable copolymer according to the present disclosure may also be more resistant to polymer degradation over time and/or due to exposure to high temperatures, again as compared to conventional polyhydroxyalkanoate homopolymers and copolymers. The polymer packing density and crystallinity of the first biodegradable copolymer may be reduced as compared to conventional polyhydroxyalkanoate homopolymers and copolymers

The overall polymer composition incorporating the first biodegradable copolymer may also exhibit improved mechanical properties derived from the improvements in the polyhydroxyalkanoate copolymer. In particular, the inclusion of the first biodegradable copolymer may reduce the need for additional plasticizers to be included in the overall polymer composition.

In addition to the first biodegradable copolymer, the polymer composition may in some instances also include one or more additional polymers. For instance, in some embodiments, the polymer composition may also include a second biodegradable polymer. This second biodegradable polymer may for instance be selected from the group consisting of polybutylene adipate terephthalate, polybutylene succinate, polybutylene succinate-co-adipate, polylactic acid, mesolactide, polycaprolactone, polyglycolide, starches, cellulose esters, polysaccharides, polyvinyl alcohol, polyvinyl acetate, polymaleic acid, copolyesters of diols having 2 to 18 carbon atoms and diacids having 2 to 18 carbon atoms, and mixtures thereof.

In such embodiments, the polymer composition may include from about 50 weight percent to about 95 weight percent of the first biodegradable copolymer and from about 5 weight percent to about 50 weight percent of the second biodegradable polymer.

Alternatively, in other embodiments, the polymer composition may include a nonbiodegradable polymer. This nonbiodegradable polymer may for instance be selected from the group consisting of polyvinyl chloride, polypropylene, polyethylene, polyethylene terephthalate, and mixtures thereof. In these embodiments, the polymer composition may include from about 50 weight percent to about 95 weight percent of the first biodegradable copolymer and from about 5 weight percent to about 50 weight percent of the nonbiodegradable polymer.

Small amounts of various other additives may also be included in the polymer composition.

For instance, in certain embodiments, the polymer composition may include from about 0.01 weight percent to about 20 weight percent of a nucleating agent selected from the group consisting of (1) compounds having an orthorhombic crystal structure, (2) compounds having a hexagonal crystal structure, (3) compounds having a tetragonal crystal structure, (4) allotrophic elements having at least one crystalline form which is orthorhombic, hexagonal, or tetragonal, (5) polymorphic compounds having at least one crystalline form which is orthorhombic, hexagonal, or tetragonal, and (6) mixtures thereof. For instance, the nucleating agent may, in some embodiments, be selected from the group consisting of artificial sweeteners, boron nitride, thymine, pentaerythritol, dipentaerythritol, anatase, wulfenite, aragonite, sulfur, selenium, phosphorous, and benzamide.

Also, in some instances, the polymer composition may include from about 1.0 weight percent to about 40 weight percent of a filler selected from the group consisting of clays, calcium carbonate, talc, kaolinite, montmorillonite, bentonite, silica, chitin, titanium dioxide, nano clay, nanocellulose, or mixtures thereof.

Additionally, the polymer composition may also from about 0.5 weight percent to about 25 weight percent of a plasticizer selected from the group consisting of sebacates, citrates, fatty esters of adipic, succinic, and glucaric acids, lactates, alkyl diesters having a having a main carbon chain of from about 2 to about 12 carbon atoms, alkyl methyl esters, dibenzoates, propylene carbonate, caprolactone diols having a weight average molecular weight from about 200 to about 10,000, polyethylene glycols diols having a weight average molecular weight from about 400 to about 10,000, esters of vegetable oils (such as soybean, canola, corn, cottonseed, sunflower, and peanut oils), long chain alkyl acids having from about 10 to about 20 carbon atoms, glycerol, isosorbide derivatives and mixtures thereof.

The various components of the polymer composition are blended in a high-performance mixer or more preferably are combined and blending inside an extruder, such as a twin-screw extruder. Typically, the mixing is carried out at a temperature from about 100 to about 210° C. In some instances, the first biodegradable copolymer may be reactively extruded with a second (or even a third, fourth, or fifth) biodegradable polymer, or with additional polyhydroxyalkanoates as referenced above.

Numerous articles of manufacture may be formed from the polymer composition according to the present disclosure. For instance, in one embodiment of the present disclosure, a molded article, such as a fork, knife, spoon, bottle, splash stick, or coffee capsule, may be formed which is made up of at least 50 weight percent of the aforementioned polymer composition.

In a second embodiment, an extruded article, such as a straw, coffee stirrer, tubing, film or sheet may be formed which is made up of at least 50 weight percent of the aforementioned polymer composition.

In a third embodiment, a fiber or filament may be formed which is made up of at least 50 weight percent of the aforementioned polymer composition.

In a fourth embodiment, a polymeric may be formed which is made up of at least 50 weight percent of the aforementioned polymer composition.

In still another embodiment, a foamed article may be formed which is made up of at least 50 weight percent of the aforementioned polymer composition.

In an additional embodiment, a dispersion, generally an aqueous dispersion, may be formed which is made up of at least 50 weight percent of the aforementioned polymer composition.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A polymer composition comprising:
a first biodegradable copolymer, the first biodegradable copolymer comprising
from about 55 to about 99.5 mole percent monomer residues of 3-hydroxybutyrate,
monomer residues of a secondary monomer selected from the group consisting of 4-hydroxybutyrate, 3-hydroxyvalerate, 4-hydroxyvalerate, and 5-hydroxyvalerate, and
monomer residues of a tertiary monomer selected from the group consisting of hydroxyalkanoate monomers having from 6 to 22 carbon atoms,
wherein the monomer residues of the secondary monomer and the tertiary monomer combined comprise from about 1 to about 35 mole percent of the first biodegradable copolymer.

2. The polymer composition of claim 1, wherein the secondary monomer comprises 3-hydroxyvalerate.

3. The polymer composition of claim 1, wherein the secondary monomer comprises 4-hydroxybutyrate.

4. The polymer composition of claim 1, wherein the secondary monomer comprises 4-hydroxyvalerate.

5. The polymer composition of claim 1, wherein the secondary monomer comprises 5-hydroxyvalerate.

6. The polymer composition of claim 1, wherein the tertiary monomer comprises 3-hydroxyhexanoate.

7. The polymer composition of claim 1, wherein the tertiary monomer comprises 3-hydroxyoctanoate.

8. The polymer composition of claim 1, wherein the tertiary monomer comprises 3-hydroxydecanoate

9. The polymer composition of claim 1, wherein the first biodegradable copolymer comprises
from about 0.01 to about 20 mole percent monomer residues of the secondary monomer, and
from about 1 to about 35 mole percent monomer residues of the tertiary monomer.

10. The polymer composition of claim 1, wherein the first biodegradable copolymer comprises
from about 1 to about 35 mole percent monomer residues of the secondary monomer, and
from about 0.01 to about 20 mole percent monomer residues of the tertiary monomer.

11. The polymer composition of claim 1, wherein the first biodegradable copolymer comprises
from about 84 to about 99.5 mole percent monomer residues of 3-hydroxybutyrate,
from about 0.1 to about 1.0 mole percent monomer residues of a secondary monomer selected from the group consisting of 4-hydroxybutyrate, 3-hydroxyvalerate, 4-hydroxyvalerate, and 5-hydroxyvalerate, and
from about 0.4 to about 15 mole percent monomer residues of a tertiary monomer selected from the group consisting of hydroxyalkanoate monomers having from 6 to 22 carbon atoms.

12. The polymer composition of claim 1, wherein the first biodegradable copolymer comprises
from about 84 to about 99.5 mole percent monomer residues of 3-hydroxybutyrate,
from about 0.4 to about 15 mole percent monomer residues of a secondary monomer selected from the group consisting of 4-hydroxybutyrate, 3-hydroxyvalerate, 4-hydroxyvalerate, and 5-hydroxyvalerate, and
from about 0.1 to about 1.0 mole percent monomer residues of a tertiary monomer selected from the group consisting of hydroxyalkanoate monomers having from 6 to 22 carbon atoms.

13. The polymer composition of claim 1, wherein the first biodegradable copolymer has a weight average molecular weight from about 50,000 to about 7.5 million Daltons.

14. The polymer composition of claim 1, wherein the first biodegradable copolymer has a weight average molecular weight from about 350,000 to about 1.5 million Daltons.

15. The polymer composition of claim 1, wherein the polymer composition comprises from about 50 weight percent to about 95 weight percent of the first biodegradable copolymer and further comprises from about 5 weight percent to about 50 weight percent of a second biodegradable polymer selected from the group consisting of polybutylene adipate terephthalate, polybutylene succinate, polybutylene succinate-co-adipate, polylactic acid, mesolactide, polycaprolactone, polyglycolide, starches, cellulose esters, polysaccharides, polyvinyl alcohol, polyvinyl acetate, polymaleic acid, copolyesters of diols having 2 to 18 carbon atoms and diacids having 2 to 18 carbon atoms, and mixtures thereof.

16. The polymer composition of claim 1, wherein the first biodegradable copolymer is blended or reactively extruded with the second biodegradable polymer

17. The polymer composition of claim 1, wherein the first biodegradable copolymer is blended or reactively extruded with additional polyhydroxyalkanoates.

18. The polymer composition of claim 1, wherein the polymer composition comprises from about 50 weight percent to about 95 weight percent of the first biodegradable copolymer and further comprises from about 5 weight percent to about 50 weight percent of a nonbiodegradable polymer selected from the group consisting of polyvinyl chloride, polypropylene, polyethylene, polyethylene terephthalate, and mixtures thereof.

19. The polymer composition of claim 1, wherein the polymer composition further comprises from about 0.01 weight percent to about 20 weight percent of a nucleating agent selected from the group consisting of (1) compounds having an orthorhombic crystal structure, (2) compounds having a hexagonal crystal structure, (3) compounds having a tetragonal crystal structure, (4) allotrophic elements having at least one crystalline form which is orthorhombic, hexagonal, or tetragonal, (5) polymorphic compounds having at least one crystalline form which is orthorhombic, hexagonal, or tetragonal, and (6) mixtures thereof.

20. The polymer composition of claim 1, wherein the polymer composition further comprises from about 1.0 weight percent to about 40 weight percent of a filler selected from the group consisting of clays, calcium carbonate, talc, kaolinite, montmorillonite, bentonite, silica, chitin, titanium dioxide, nano clay, nanocellulose, or mixtures thereof.

21. The polymer composition of claim 1, wherein the polymer composition further comprises from about 0.5 weight percent to about 25 weight percent of a plasticizer selected from the group consisting of sebacates, citrates, fatty esters of adipic, succinic, and glucaric acids, lactates, alkyl diesters having a having a main carbon chain of from about 2 to about 12 carbon atoms, alkyl methyl esters, dibenzoates, propylene carbonate, caprolactone diols having a weight average molecular weight from about 200 to about 10,000, polyethylene glycols diols having a weight average molecular weight from about 400 to about 10,000, esters of vegetable oils, long chain alkyl acids having from about 10 to about 20 carbon atoms, glycerol, isosorbide derivatives and mixtures thereof.

22. A molded article comprising at least 50 weight percent of the polymer composition of claim 1.

23. An extruded article comprising at least 50 weight percent of the polymer composition of claim 1.

24. A fiber or filament comprising at least 50 weight percent of the polymer composition of claim 1.

25. A polymeric film comprising at least 50 weight percent of the polymer composition of claim 1.

26. A foamed article comprising at least 50 weight percent of the polymer composition of claim 1.

27. A dispersion comprising at least 50 weight percent of the polymer composition of claim 1.
